(19) United States
(12) Patent Application Publication
(10) Pub. No.: US 2012/0295005 A1
(43) Pub. Date: Nov. 22, 2012

(54) APPARATUS AND METHOD FOR DRY SPICE APPLICATION

(76) Inventors: Thomas W. Kleckner, McFarland, WI (US); Amber Lynne Engelke, Cottage Grove, WI (US)

(21) Appl. No.: 13/468,775

(22) Filed: May 10, 2012

Related U.S. Application Data
(60) Provisional application No. 61/487,854, filed on May 19, 2011.

(51) Int. Cl. A23L 1/317; A22C 11/08; A22C 11/02; A22C 11/06; A23L 1/314; B05C 19/04

(52) U.S. Cl. 426/574; 426/646; 118/24; 452/35; 452/45; 452/44; 452/40

(57) ABSTRACT

An apparatus and method of applying dry ingredients to a meat includes a stuffing horn with separate flow channels. An outer elongated flow channel is configured to have tubular casings disposed therearound. An inner elongated flow channel is disposed within the outer elongated flow channel. A first inlet is configured to introduce a meat stream into the inner elongated flow channel. A second inlet, connected to the inner elongated flow channel, is configured to introduce dry ingredients into the conduit between the outer and inner elongated flow channels. At the end of the stuffing horn, the inner and outer elongated flow channels are configured to create a void space around the meat stream where the dry ingredients are deposited onto an outside surface of the meat stream prior to the meat stream being deposited into a tubular casing.

### CROSS-REFERENCE TO RELATED APPLICATION

This application claims the benefit of U.S. Provisional Application No. 61/487,854, filed May 19, 2011, which is hereby incorporated by reference in its entirety.

### TECHNICAL FIELD

This invention relates generally to methods and apparatus for applying dry ingredients to a food product. More particularly, the invention relates to the application of dry ingredients to meat, meat analogs, or meat products.

### BACKGROUND

Meat and meat products are popular foods that are relatively high in protein. Such meat products include sliced or shaved meats, sausages, and hot dogs, to note but a few. These products are typically mixed or combined with ingredients such as flavorings, curing agents, spices, color and texture enhancers, denaturing ingredients, and food additives for safety and freshness, among other concerns. Dry ingredients are often added to meat mixtures during the blending stage of the process or, alternatively, can be added after the cooked products are removed from the casing. As used herein, meat mixtures may include a whole muscle meat mixture, a meat batter, and a meat substitute or meat analog mixture.

Adding the dry ingredients during blending or mixing may limit the variety of product offerings to consumers. Meat products are typically produced in large batches and it may be difficult to customize a larger batch into smaller batches that have a variety of different flavors if the batch must be divided and separately mixed with the different ingredients. In addition, consumers often desire a product where the dry ingredients (such as seasonings) have been added to the surface of the meat, which can provide the product with a less-processed appearance. More particularly, consumers sometimes prefer that the outer surface of the meat product be coated with seasoning. Having the dry ingredients on the surface of the meat also may require less of the dry ingredients to provide a similar flavor experience than would be required if the ingredients were mixed into the meat mixture.

To allow the ingredients to be applied to the outer surface of the meat, it is known to mix the dry ingredients with a gel or liquid to provide a carrier for these ingredients, e.g., spices. This pre-blended gel/liquid mixture is typically applied to and adheres to the outside surface of the meat. This application of the gel/liquid mixture occurs as the meat is being stuffed into the casing, prior to cooking. When the meat product is then cooked, the gel/liquid mixture is dried and the ingredients that were applied in gel/liquid carrier are set to the outside surface of the meat. In addition to setting the ingredients on the outside surface of the meat, cooking typically removes the gel/liquid carrier to avoid having a sticky or gooey film left behind on the surface of the meat. Not only is a sticky, gooey film generally unappetizing, it can make the ingredients stick to the casing, and not to the surface of the meat, such that when the casing is removed prior to consumption of the meat, the ingredients are also removed from the meat. Since the gel/liquid drying occurs, in part, during the cooking process, cook times associated with the gel/liquid application are typically longer and hotter to ensure adequate drying time and heat. Furthermore, the casings typically used in gel/liquid applications have very large stuck holes through which moisture is allowed to escape, however, such large openings in the casing permit yield loss, in addition to moisture loss. Yield loss also is increased in the gel/liquid application due to the longer cook times.

Structurally, the stuffing apparatus employed for the known gel/liquid application includes a coextruder with a central, inner passage and a coaxial outer, annular passage such as shown in CA 2,260,390. The exit from the coextruding stuffing apparatus is inclined so that there is a delay between the exit of the meat log and the carrier from the apparatus. This delay allows the meat log to expand prior to exit of the carrier from the apparatus to avoid intermixing and blending of these ingredients in the meat.

Both coextruded streams are under pressure and the gel/liquid carrier in the outer passage typically has a viscosity that ranges from about 6.0 to 7.0. There are a number of additional concerns regarding the gel/liquid application of dry ingredients, including the elevated pressures needed to apply the gel/liquid mixtures. More specifically, the pressure of the gel/liquid mixture as it is pumped through the stuffing horn is typically around 80-90 psi. Overall, the gel/liquid application process tends to be slower due to the relatively higher viscosity of the carrier gel/liquid. Further, pressurized tanks or vessels are typically employed to move the gel/liquid carrier through the system. Further, extruding two liquids (the meat and the gel/liquid mixture) results in a slower process because of the increased complexity within the system and because the system is tailored to the slowest moving liquid that is extruded. More particularly, since the gel/liquid carrier is pumped at a lower rate due to its viscosity, the meat stream also is pumped at a lower speed to accommodate application of the spices which are pumped at a lower speed with the gel/liquid carrier.

In sum, the known gel/liquid application of the ingredients is time consuming because the drying time needed for the gel/liquid carrier and because of limitations on how fast the gel/liquid carrier can be extruded along with the meat. The amount of ingredients that can be applied is also limited with a gel/liquid application. For example, if the gel/liquid mixture is too thick, the carrier generally does not properly cook off and a film may remain on the outside surface of the meat. The gel/liquid application also requires time consuming additional steps. These include preparing the gel/liquid mixture ahead of time which further requires that precise measurements of the carrier and the various dry ingredients be undertaken. The gel/liquid mixture, however, can not be prepared too far ahead of time due to concerns with the consistency of texture and flavor varying before the mixture is coextruded with the meat product.

In another approach, the dry ingredients are applied once the meat product is cooked and the casing is removed. This alternative approach avoids the elevated cook temperatures and longer cook times associated with the gel/liquid application; however, applying dry ingredients subsequent to cooking employs an additional process that requires removal of the casing and subsequent application of the dry ingredients to the outside surface of the cooked meat product.

### SUMMARY

In one aspect, an apparatus for applying dry ingredients to meat is provided with the apparatus having an air flow device including a dry ingredient entrainment mechanism, which cooperates with a meat extruder so that the air entrained dry ingredients are generally uniformly applied on at least predetermined circumferential section, if not completely around, an outer surface of meat product as it extrudes out from the extruder. By entraining the dry ingredients in an airstream, the dry ingredients are applied to the outer surface of meat in their natural state reducing complexities associated with the use of prior gel liquid dry ingredient carrier systems. The term natural state is used to describe the dry ingredients not being exposed to a liquid or gel carrier, which could affect, for example, the consistency of the dry ingredients. In this regard, the apparatus herein allows cook times and/or temperatures to be reduced since the natural state application of the dry ingredients requires no additional cook or heat to dry the meat product from a gel liquid carrier for the dry ingredients.

More particularly, the air flow device preferably has an exit end upstream of the exit end of the meat extruder. In one form, the exit ends have gap spacings from each other in both the longitudinal meat and air travel directions and in the radial direction. A low pressure dry ingredient application zone is provided between the exit end of the air flow device and the exit of the meat extruder. The dry ingredients leave the upstream exit end of the air flow device to travel through the low pressure dry ingredient application zone, and are directed onto the meat outer surface as the meat exits the extruder exit end. In this manner, any mixing or blending of the dry ingredients into the body of the meat product is avoided or kept to a minimum.

In another form, the meat extruder has an exit extension that projects further downstream from the remainder of the exit end upstream from the extension to restrict the expansion of the meat product along the exit extension as the meat product is extruded out from the exit end. The air flow device includes a plurality of air conduits that are arranged to be aligned with the exit extension. With the exit extension, the meat product is allowed to expand due to the pressure differential between the pressure inside and outside the meat extruder as the meat product is extruded from the upstream portion of the exit end lacking the extension.

As the meat product exits from the extension, the meat product in this region will expand more gradually thus presenting a greater surface area on the outer surface along which the air entrained dry ingredients from the extension aligned air conducts will be directed for a more uniform application of dry ingredients on this section of the outer surface.

In yet another form, the meat extrusion direction and the air flow direction are generally parallel, and the exit end of the meat extruder has an outwardly tapered annular wall portion that extends obliquely to the meat extrusion and air flow directions. In this manner, the meat product is extruded along the tapered wall portion, it will begin to gradually expand radially with the gradual radial expansion continuous as the meat product exits from the extruder exit end. The gradual radial expansion creates an inclination of the meat product outer surface that extends obliquely to the air flow direction so that dry ingredients are applied over a larger area of the outer surface versus an apparatus that allows the meat product to expand previously in the radial direction orthogonal to the meat extrusion direction.

In another aspect, an apparatus for applying dry ingredients to meat is provided and includes a stuffing horn with separate, elongated flow channels. Exit ends of the elongated flow channels are configured to provide space for the dry ingredients to be applied to an exposed surface area of the meat exiting from its flow channel. Such a void space provides an open area adjacent the exit of the stuffing horn that is not filled by the meat stream and where the dry ingredients may diffuse or blow over the surface area of the meat. A number of configurations can be employed to provide a void space where the dry ingredients can be applied. In one configuration, the meat stream is depressurized after the dry ingredients are discharged from the exit end of their flow channel or channels and before application of the dry ingredients so that there is a low pressure application of the dry ingredients to the meat.

In a preferred form, the apparatus has a stuffing horn that includes a generally cylindrical outer wall and a generally cylindrical inner wall extending coaxially in the outer wall so that there is an elongate annular space between outer and inner cylindrical walls. A meat supply device provides a pressurized flow of meat product to an upstream end of the inner wall so that the meat product flows under pressure therethrough downstream to an exit end thereof. A plurality of elongate tubular members are arranged in the annular space. An air flow device provides a flow of air to upstream ends of the tubular members, and a dry ingredient entrainment mechanism provides the dry ingredients to the air flow device so that the dry ingredients are entrained in the air flow through the tubular members downstream to exit ends thereof. The tubular members are arranged in the annular spaced to be radially spaced from the inner wall and so that their exit ends are longitudinally spaced upstream from the exit end of the inner wall. In this manner, there is distinct void space or zone between the discharge ends of the tubular members and the discharge end of the inner wall that is traversed by the dry ingredients prior to engaging the meat product exiting the downstream and radially inner discharge end of the inner wall. Since the dry ingredients are under relatively low pressure as they travel through the tubular members, e.g., 1-2 psi, and must traverse the void space that is substantially open to atmospheric pressure, the dry ingredients are gently applied to the meat product outer surface greatly reducing the possibility of having the ingredients penetrate the meat product outer surface to intermix with the body thereof. Further, by gently blowing the air entrained dry ingredients through the void space or low pressure zone, the dry ingredients will be spread out across the meat product outer surface for a more uniform application of dry ingredients thereon.

In another aspect, the method for applying dry ingredients to a meat log may include introducing a meat stream into the inner elongated flow channel and introducing the dry ingredients into the outer elongated flow channel. The method may also include depressurizing the meat stream after the dry ingredients have been discharged to the application area where they are to be applied to the meat. The dry ingredients are entrained in an air stream to advance the ingredients down the conduit. The meat stream may be pumped through the inner elongated flow channel. At the exit of the stuffing horn, the dry ingredients are deposited on the outside surface of the meat stream. Applying the ingredients in a dry form reduces the required cook time and/or heat thereof, since the gel/liquid carrier is not needed. Furthermore, the dry ingredient application method permits the yield loss to be minimized by reducing the required cook time.

In another aspect, a plurality of hoses, channels, or tubes may be arranged within the conduit between the inner and outer elongated flow channels. These tubes may be distributed within the conduit to provide distinct passageways within which the dry ingredients travel through the conduit. The tubes help prevent pooling of the dry ingredients in one portion of the conduit and help direct the dry ingredients to the space where the dry ingredients are to be applied to the outside surface of the meat stream.

In yet another aspect, the dry ingredients are entrained in an air stream to advance the dry ingredients from an inlet of the stuffing horn to the end where the dry ingredients are applied to a surface area of the meat stream. To entrain the dry ingredients in an air stream a pump, such as a venturi pump, may be employed. Furthermore, if a plurality of tubes is used to move the dry ingredients through the conduit, the space between the tubes may be used to vent the air out of the casing. By one approach, each of the plurality of tubes may deliver approximately 0.1 to 0.2 ounces-per-second of the dry ingredient to the void space. In addition, a volume of approximately 0.5 to 12.0 ft³/hour dry ingredients may be advanced within the conduit.

So configured and arranged those skilled in the art will recognize that these teachings will provide for efficiently and economically applying dry ingredients to the surface of the meat by reducing the required cook time such that less yield loss is experienced. This is accomplished by removing the drying process previously used in gel/liquid applications. Furthermore, the process described herein permits a larger amount of ingredients to be applied to the meat and also allows larger ingredient particles to be applied. By applying the dry ingredients without the carrier required for the gel/liquid application, the process discussed herein gains additional flexibility. For example, unlike the gel/liquid application process, a number of different casings can be employed with these teachings, thereby making this a more flexible process than the gel/liquid process and also easier to incorporate into other applications. More particularly, while large stuck holes are needed in the casings employed with a gel/liquid application to thereby allow moisture to escape, the casings used with the teachings herein may have large or small stuck holes or may not have any stuck holes. Indeed, casings employed with the present teachings may include fibrous permeable casings such as pre-stuck casings having a variety of hole sizes from large to small, non-stuck casings, impermeable casings such as a cook-in-bag, or a co-extruded casing such as those applied to the outside surface of the meat at the bagging step, to note but a few options. Further, the teachings herein permit the meat product to be extruded along with the dry ingredients that are entrained in air such that the dry ingredients are applied as the meat product is filled into casings. As a result, the system discussed herein acquires some flexibility such that the ingredients may be applied to the meat efficiently and economically.

Furthermore, without a gel/liquid carrier, the system may be run at a much lower pressure. For example, while the gel/liquid mixture is typically pressurized at around 80-90 psi, the dry ingredients may be advanced through the stuffing horn and applied to the meat at less than 10 psi. In one illustrative application, the pressure of the dry ingredients may be around 1-2 psi. Since the elevated pressures of a system with a gel/liquid carrier requires additional safety measures, by lowering the operating pressure, the system with a dry application can be run faster and without requiring the same safety measures. Efficiencies in the dry application discussed herein also resulted from the elimination of certain steps previously required. For example, while the dry ingredients may be placed into the hopper that feeds into the stuffing horn, the gel/liquid mixture must be prepared ahead of time in a separate process prior to being introduced into the stuffing horn.

### BRIEF DESCRIPTION OF THE DRAWINGS

FIG. 1 comprises a schematic diagram as configured in accordance with various embodiments of the invention;

FIG. 2 comprises a perspective view of a portion of a first embodiment as configured in accordance with various embodiments of the invention;

FIG. 3 comprises a cross sectional view of a portion of the embodiment of FIG. 2 as configured in accordance with various embodiments of the invention;

FIG. 4 comprises a side view of a portion of second embodiment configured in accordance with various embodiments of the invention;

FIG. 5 comprises an end view of the embodiment of FIG. 4 as configured in accordance with various embodiments of the invention;

FIG. 6 comprises a perspective view of a portion of a third embodiment as configured in accordance with various embodiments of the invention;

FIG. 7 comprises a cross sectional view of another portion of the third embodiment of FIG. 6 as configured in accordance with various embodiments of the invention;

FIG. 8 comprises a perspective view of a portion of a fourth embodiment as configured in accordance with various embodiments of the invention;

FIG. 9A comprises a perspective view of a portion of a fifth embodiment as configured in accordance with various embodiments of the invention;

FIG. 9B comprises a side view of the fifth embodiment of FIG. 9A;

FIG. 10 comprises a cross sectional view of a portion of a sixth embodiment as configured in accordance with various embodiments of the invention;

FIG. 11 comprises a cross sectional view as configured in accordance with various embodiments of the invention;

FIG. 12 comprises a cross sectional view as configured in accordance with various embodiments of the invention;

FIG. 13 comprises a cross sectional view as configured in accordance with various embodiments of the invention;

FIG. 14 comprises a detail view as configured in accordance with various embodiments of the invention;

FIG. 15 comprises a detail view as configured in accordance with various embodiments of the invention;

FIG. 16 comprises a detail view as configured in accordance with various embodiments of the invention; and

FIG. 17 comprises a flow diagram as configured in accordance with various embodiments of the invention.

### DETAILED DESCRIPTION OF THE PREFERRED EMBODIMENTS

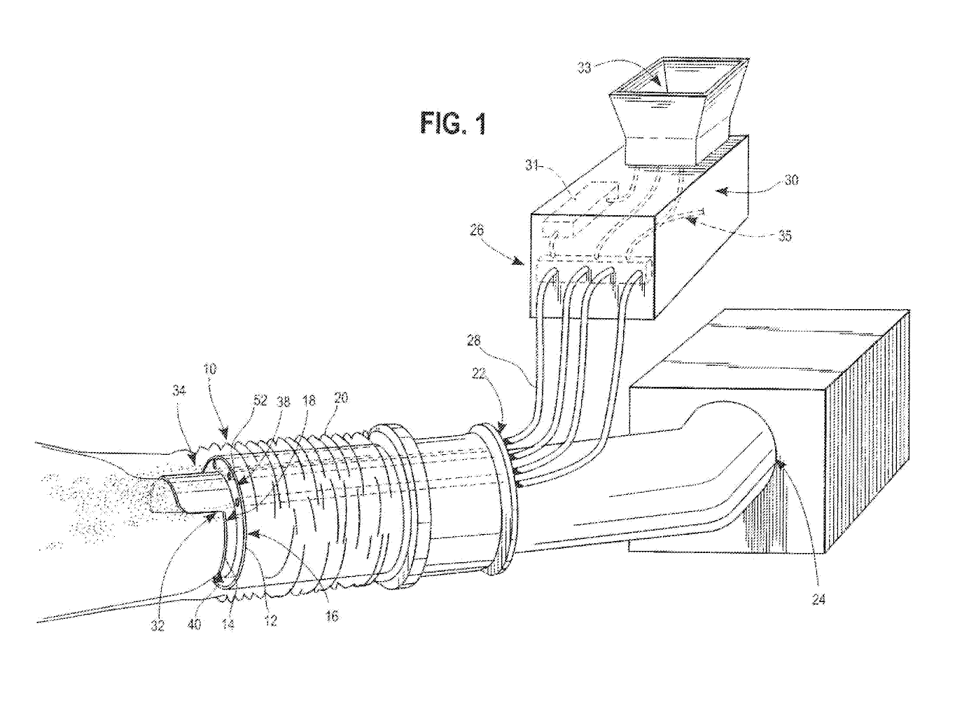

Referring now to the drawings, and in particular to FIG. 1, an illustrative apparatus 10 that is compatible with many of these teachings will now be presented. The stuffing horn 10, schematically represented in FIG. 1, includes an outer elongated flow channel 12 and an inner elongated flow channel 14. In one illustrative embodiment, the inner and outer elongated flow channels 12, 14 have substantially constant diameters along their lengths. The flow channels are arranged such that a conduit 16 is positioned between the inner elongated flow channel 14 and the outer elongated flow channel 12. In one approach, the flow channels 12, 14 are coaxially arranged such that the conduit 16 is an annularly shaped opening. The conduit 16 runs generally parallel to an inner opening 18 inside the inner elongated flow channel 14. The conduit 16 may have one or a plurality of tubes, channels, or hoses 52 through which the dry ingredients are advanced through the conduit 16. The outer elongated flow channel 12 is configured to have tubular casings 20 disposed therearound. Thus, the dry ingredients are applied to the meat stream as the meat product is being filled into casings.

The inner elongated flow channel 14 is at least partially disposed within the outer elongated flow channel 12 and the flow channels 12, 14 may have a variety of diameters and cross-sections. It is anticipated that the inner elongated flow channel 14 may have a diameter between approximately 1.0 to 5.0-inches and the outer elongated flow channel 12 may have a diameter between approximately 2.0 to 8.0-inches, though other diameters are contemplated. In one illustrative example, the inner and outer elongated flow channels are pipes or tubes with a circular cross section, the outer elongated flow channel 12 having approximately a 4.0-inch diameter. Furthermore, the inner elongated flow channel 14 may have approximately a 3.0-inch diameter and an inner diameter of approximately 2.85-inches. As discussed below, the flow channels may be comprised of a variety of materials including stainless steal and other food grade materials.

A first inlet 22 is connected to an upstream end of the outer elongated channel 12 and a second inlet 24 is connected to an upstream end of the inner elongated flow channel 14. Further, the first inlet 22 may direct or introduce dry ingredients into the conduit 16 between the inner and outer elongated flow channels 12, 14. The second inlet 24 may direct or introduce meat into the inner elongated flow channel 14. As used herein, the meat may include a whole meat mixture, a meat batter, and a meat analog mixture, to note a few options. The second inlet 24 may be connected to a meat pump system that is configured to advance the meat through the inner opening 18 of the inner elongated flow channel 14.

The first inlet 22 is connected to a dry ingredient delivery system 26. For the dry ingredient delivery system 26, a variety of configurations are contemplated. In one illustrative embodiment, the dry ingredient delivery system 26 includes a plurality of tubes or hoses 28 to deliver the dry ingredients to the first inlet 22. In another configuration, the system 26 may include a single conduit to deliver the dry ingredients to the first inlet 22, which may or may not branch out or separate into a plurality of separate smaller conduits. The delivery system 26 may further include a bin 30 that houses a screw feed system. The screw feed system may include a single screw feeder or a series of screw feeders. The screw feed controls, at least partially, the speed with which the spice enters the stuffing horn. Furthermore, the screw feed system may include a single hopper and drive or multiple hoppers and drives. The dry ingredient delivery system 26 may also include a dry ingredient pump 31, e.g., a diaphragm pump, configured to advance the dry ingredients through the conduit located between the inner and outer elongated flow channels. By one approach, the dry ingredient pump may include a venturi-style pump 35 configured to receive the dry ingredients from a screw feeder 33 and advance the ingredients through the inlet and through the conduit. Such a venturi-style pump may move the dry ingredients downstream by entraining the at least one dry ingredient in a moving air stream. In some configurations, a plurality of dry ingredient pumps may be employed to move the dry ingredients downstream. The dry ingredients may include a wide variety of spices, flavorings, and additives for safety and freshness, to note but a few of the dry ingredients added to meat products. In one illustrative example, the dry ingredients may include paprika, pepper, cellulose, starch, salt, and sugar, among many others.

An end portion 32 of the stuffing horn is configured to create an opening or void space 34 around a portion of the meat. The end portion 32 includes first and second exits 38, 40. The outer elongated flow channel 12 has a first exit 38 and the inner elongated flow channel 14 has a second exit 40. The dry ingredients are deposited onto an outside surface of the meat at and around the void space.

The void space 34 may be created in a number of manners. As used herein, the void space is a gap that primarily provides separation between the casing and the meat where the dry ingredients can be applied to the outside surface of the meat. More specifically, the void space 34 is located adjacent the exit of the flow channel 14, which contains the meat and includes the space that is created prior to when the meat contacts the casing. The void space 34 permits application of the dry ingredients to the meat before the meat adheres to the casing. Once the casing is in contact with the outside surface of the meat, there is no room for the dry ingredients to be applied.

The void space 34 works in conjunction with the exits 38, 40 of the inner and outer flow channels 12, 14. The exit 40 of the inner elongated flow channel 14 allows the meat stream to depressurize prior to exposure to the void space 34 or exposure to the dry ingredients. For example, the exit 40 may permit the meat to expand prior to exposure to the void space 34 or may allows the meat stream to move in a direction away from the void space 34. Therefore, the void space 34 remains at least partially open and free of the meat stream such that the meat stream does not entirely fill the void space 34. Such a depressurization of the meat stream occurs prior to the application of the dry ingredients. By depressurizing the meat and/or allowing it to expand, the meat stream achieves a more laminar flow that is less turbulent. If the back pressure of the meat stream is too high, in some cases, the meat stream can back up and flow up into the dry ingredient tubes or channels 52 that are disposed in conduit 16. Further, even if the meat stream does not create excessive back pressure, it can fill the casing too quickly such that there is no room for the dry ingredients to be applied to the surface of the meat. By allowing the meat stream to depressurizing prior to exposure to the dry ingredients, the risk of having the meat stream fill the casing too quickly or back up into the dry ingredient tubes 52 is greatly decreased. Thus, the dry ingredients have an opportunity to be applied to the surface of the meat stream.

Also, the void space 34 allows the dry ingredients to spread out such that they can blow, expand, or diffuse over a larger portion of the surface area of the meat stream. By having a separation between the casing and the meat, the dry ingredients are free to flow and become applied to the outside surface of the meat. The void space 34 is, in part, created by having the meat stream expand or depressurize prior to exposure to the dry ingredients and, thus, the dry ingredients are able to expand or diffuse to cover a greater portion of the surface area of the meat stream. Also, the void space eliminates or greatly decreases the back pressure on the dry ingredient stream and allows the dry ingredients sufficient time to contact the surface of the meat prior to the meat contacting the casing. Further, by allowing the dry ingredients to be applied to the surface of the meat at the exit of the inner elongated flow channel, the dry ingredients are not merely mixed into the meat stream.

Several examples of void spaces 34 are provided herein. To produce the void space 34, the meat stream may expand in a uniform manner or the meat may expand in an asymmetrical manner. By one approach, the end portion 32 of the stuffing horn at second exit 40 includes an inner elongated flow channel 14 that terminates asymmetrically (such that the meat stream expands asymmetrically). In another illustrative approach, the second exit 40 of the inner elongated flow channel 14 has an expanding diameter (such that the meat stream expands consistently around the circumference of the inner elongated flow channel). By another approach, the void space 34 is partially created by staggering the termination points of the inner and outer elongated flow channels. More particularly, the second exit 40 may terminate upstream or down stream of the first exit 38 of the outer elongated flow channel 12. For example, the inner elongated flow channel may extend past the end of the outer elongated flow channel such that the outer elongated flow channel appears set back. Further, such a configuration may be incorporated into one of the other configurations. For example, the asymmetrical exit of the inner elongated flow channel or the expanding diameter of the inner elongated flow channel may have an outer elongated flow channel that is set back from the inner elongated flow channel.

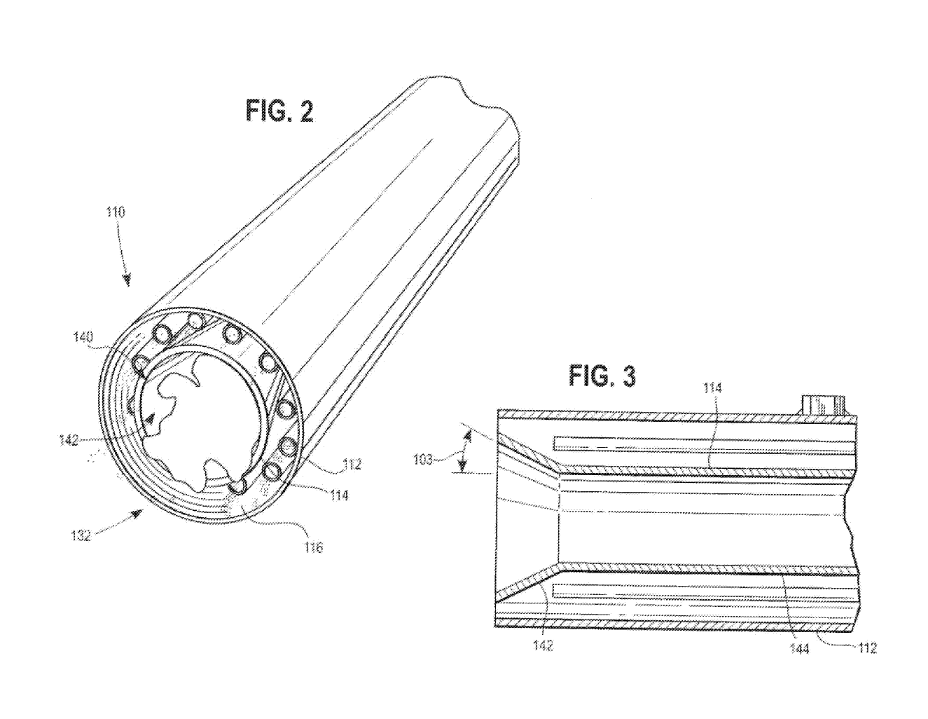

Turning now to FIG. 2, one configuration of the end portion is illustrated as reference numeral 132, with the casing removed. In this illustrative embodiment, stuffing horn 110 includes inner elongated flow channel 114 through which the meat stream passes. The inner elongated flow channel 114 has an expanding diameter portion 142 at exit 140. By expanding the diameter of the inner elongated flow channel 114, the meat stream within the flow channel 114 is able to depressurize at the expanding diameter. A variety of configurations of the expanding diameter portion 142 are contemplated. For example, a variety of angles are contemplated between the expanding diameter portion 142 and the upstream contestant diameter portion 144 of the inner elongated flow channel 114. The angle at the exit may be just slightly above zero, may be as large as 45°, or may be somewhere in between. The rate of expansion may be chosen, in part, based on the meat flowing through the inner elongated flow channel 114. Furthermore, the rate of expansion of the diameter may be constant such that the expanding portion is somewhat cone shaped, or it may increase such that the expanding portion is horn or trumpet shaped. If a fluted or horn shaped expanding diameter portion 144 is contemplated, the angle at the end may be larger than 30° or even 45°.

FIG. 3 shows stuffing horn 110 in cross section with outer elongated flow channel 112 around inner elongated flow channel 114. The inner elongated flow channel includes constant diameter portion 144 and expanding diameter portion 142 downstream of the constant diameter portion 144. The expanding diameter portion 142 has a diameter that is increasingly larger than the substantially constant diameter 142.

As shown in FIG. 3, the slope of the expanding diameter portion 142 or the angle 103 between the constant diameter portion 144 and the expanding diameter portion 142 may be approximately 15° and the length of the slopped portion may be 1.03-inches. As mentioned above, it is anticipated that the inner elongated flow channel may have a diameter between 1.0 to 5.0-inches and the outer elongated flow channel may have a diameter between approximately 2.0 to 8.0-inches. In the embodiment of FIG. 3, the outer elongated flow channel 112 has a diameter of approximately 3.0-inches and the inner elongated flow channel 114 has a constant diameter portion 144 having a diameter of approximately 1.5-inches. The diameter of the inner elongated flow channel 114 when it terminates is about 2.25-inches, which is approximately 0.75-inches smaller than the 3.0-inch outer elongated flow channel 112. Once the wall thickness of the channels is factored in, an annular opening of about 0.25-inches is present between the inner and outer elongated flow channels 112, 114. In another illustrative embodiment, the distance between the flow channels at the termination point is about 0.2-inch.

While the illustrative embodiment of FIG. 3 shows one option for sizing of the stuffing horn, numerous other sizes and configurations are contemplated. For example, depending on the amount of dry ingredient desired, the conduit 16 (the space between the inner and outer elongated flow channels 12, 14) may be increased in size by having a larger outer elongated flow channel 12 or a smaller inner elongated flow channel 14. In sum, the dimensions provided above are illustrative and many others are contemplated.

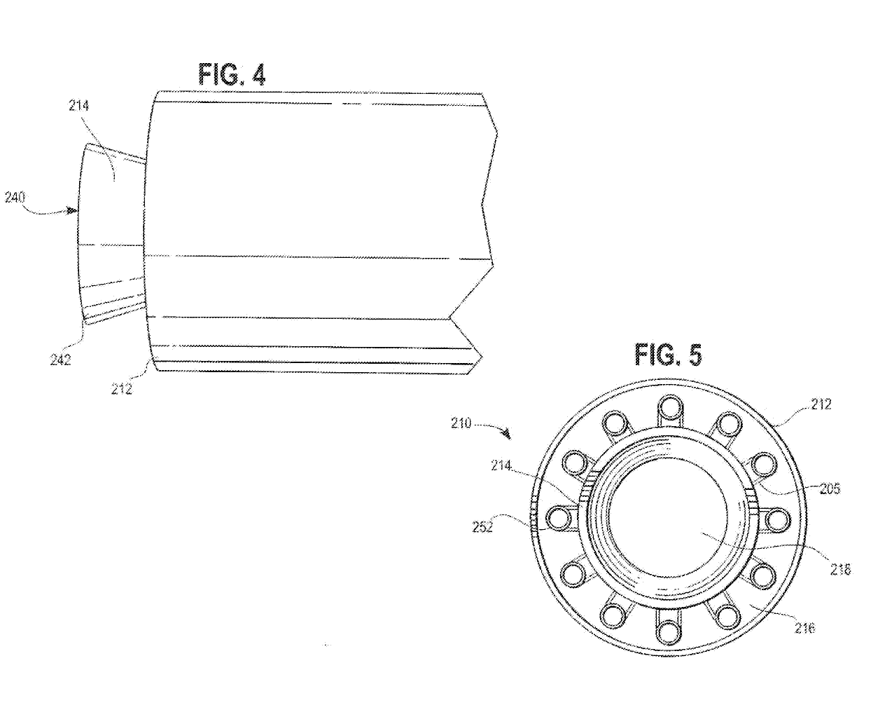

The inner and outer elongated flow channels illustrated in FIG. 3 terminate at a point in the same vertical plane such that the end points of the two flow channels are flush with one another. It is anticipated, however, that either the inner or outer elongated flow channels may terminate upstream or downstream from the other of the flow channel. As illustrated in FIG. 4, the inner elongated flow channel 214 may extend past the termination point of the outer elongated flow channel 212 such that the outer channel is set back. The inner elongated flow channel 214 illustrated in FIG. 4 has a expanding diameter portion 242 similar to that described with respect to FIG. 3, however, the embodiment of FIG. 4 has an inner elongated flow channel 214 that extends beyond the outer elongated flow channel 212 and, thus, the meat product is maintained within the flow channel 212 longer than the dry ingredients are surrounded by the outer elongated flow channel 214. Thus, the dry ingredients are permitted to expand outside of the outer elongated flow channel 214 to the casing 20 before the meat product exits the inner elongated flow channel 212.

The configuration of the stuffing horn and the termination points of the flow channels may depend on the desired final meat product. As mentioned above, the void space 34 that is created is affected by the configuration of exit 40. As illustrated in FIG. 4, an exit 240 having an expanding diameter 242 with a frustoconical configuration permits the meat stream to expand outward in all directions around the circumference of the inner elongated flow channel 214. Further, an expanding diameter portion 242 with a fustoconical configuration allows a continuous void space 234 to be created around the circumference of the expanding diameter portion 242, as discussed in more detail below.

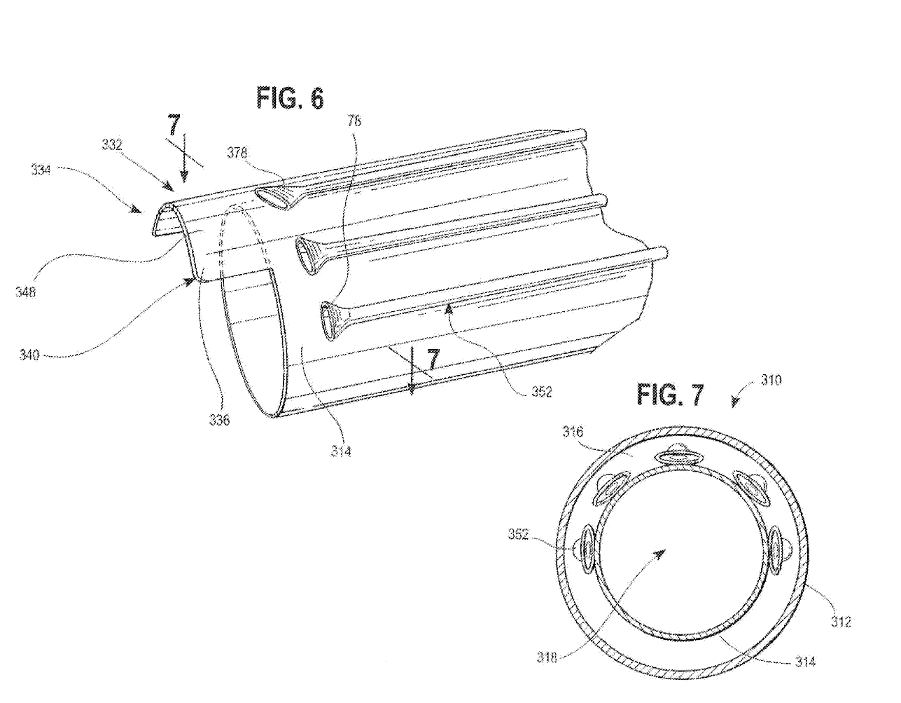

Turning now to FIG. 6, another stuffing horn configuration 310 is illustrated having end portion 332. FIG. 6 is similar to the configuration of FIG. 1, however, the outer elongated flow channel is removed from stuffing horn 310 to more fully illustrate the asymmetrical end portion 332. As suggested above, the asymmetrically terminating end portion allows the meat stream to expand asymmetrically away from the extended portion of the inner elongated flow channel. The asymmetrically configured end portion 332 includes an inner elongated flow channel 314 that does not terminate uniformly in a single vertical plane. Instead, the second exit 340 of the inner elongated flow channel 314 has an extended portion 346 that terminates downstream of the remainder of the second exit 340. By having a portion of the inner elongated flow channel extend outward from the remainder of the channel, the meat stream is allowed to expand downward, away from the extended portion 346, which depressurizes the meat, and thus, when the guard pieces 346 terminates, the pressure of the meat does not rapidly cause the meat to expand into the void space that is created therearound.

As shown in FIG. 6, the extended portion 336 may have a guard piece 348 that extends past the remainder of the inner elongated flow channel 314. More particularly, the guard piece 348 extends from the inner elongated flow channel around a portion of the circumference of the channel. The guard piece 348 may have a variety of configurations. A guard piece 348 having linear side edges and an arcuate trailing edge is illustrated in FIG. 6, however, numerous other configurations are contemplated.

FIGS. 6 and 7 also illustrate how dry ingredient tubes or channels 352 may be arranged around the inner elongated flow channel 314. These channels 352 are disposed in the conduit 16 (as shown in FIG. 1) between the inner and outer elongated flow channels, as discussed more fully below. These channels 352 may be welded into position around the inner elongated flow channel 314. FIGS. 6 and 7 illustrate the spacing of the dry ingredient channels 352 and this space may be used to vent the air from the end of the stuffing horn 310. More specifically, the air used to move the dry ingredient down the channels 352 may be exhausted back through the space between the channels 352.

FIG. 7 illustrates the stuffing horn 310 of FIG. 6 and includes the outer elongated flow channel 312. As discussed below, the channels 352 may have a pinched or somewhat flattened end portion 378, which has the same circumference as the remainder of the channel 352, but has an oval cross section. FIG. 7 illustrates how the long axis of the oval profile may be arranged tangential to the inner elongated flow channel 314. The flattened end portion 378 permits the dry ingredients to diffuse around the surface area so that the dry ingredients may be deposited on a wider area around the surface of the meat stream. FIG. 7 illustrates the oval cross section of the channels 352 at the exit and also the circular cross section of the channels 352 upstream of the exit.

The configuration of the guard piece including the shape and size may depend on the desired final meat product. More particularly, in the asymmetrical horn configuration, the guard piece permits a void space to be created adjacent to the extended portion. In one illustrative embodiment, the void space is created at the extended portion by allowing the meat to expand in the direction opposite the guard piece such that, when the extended portion terminates, the meat will not rapidly expand but will slowly expand and permit the dry ingredients to apply on the outer surface of the meat, as opposed to merely being mixed with the meat.

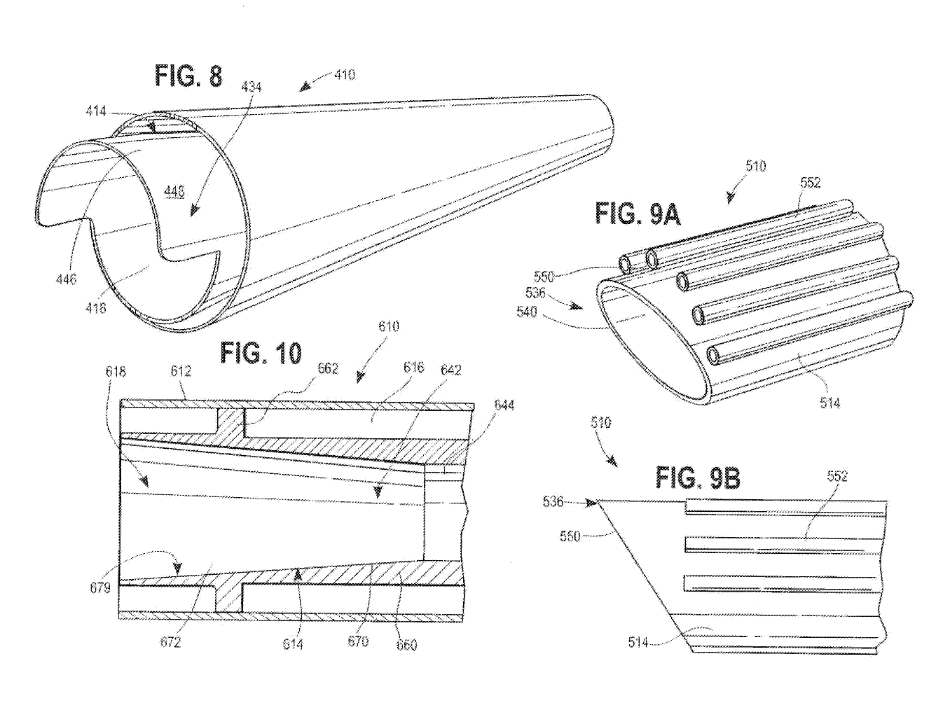

As mentioned, the guard piece may have a variety of configurations and it is anticipated that the extended portion may extended around the circumference of the meat in a variety of configurations. FIG. 8 shows a similar, albeit slightly larger horn 410, having an inner elongated flow channel 414 with an extended portion 446 comprised of a guard piece 448. While the guard piece 348 of FIG. 6 extended from less than a third of the circumference of the inner elongated flow channel 314, guard piece 448 of FIG. 8 extends about nearly half of the circumference of the flow channel 414 and meat exiting the inner opening 418. Thus, the meat stream exiting the inner elongated flow channel 314 is permitted to expand downward, past the portion of the channel lacking the guard pieces 448. Thus, a void space is created about nearly half of the circumference and the dry ingredients may be applied to the surface of the meat stream about nearly a half of the circumference of the meat stream.

It is anticipated that the guard piece may be manufactured in a variety of manners. For example, the guard piece may be a separate piece that is welded or otherwise attached to the inner elongated flow channel. Alternatively, the guard piece may be of one piece construction with the inner elongated flow channel.

FIGS. 9A-B include an exemplary embodiment illustrating another asymmetrical exit of the inner elongated flow channel. A portion of stuffing horn 510 is shown and includes a second exit 540 with an extended portion 536 having a slanted tip 550 that terminates at an angle. The slanted tip may be produced by having an angled terminating end of the inner elongated flow channel or, alternatively, may include a separate piece that is attached to the inner elongated flow channel. The slanted tip 550 may include a variety of angles. For example, the slanted tip 550 may be just slightly angled beyond a vertically oriented termination or the slanted top may extend more than 45° from the vertical orientation.

As discussed above, the asymmetrical exit can be configured in variety of manners (guard piece and slated tip, to note but two options). Further, the asymmetrical exit may be configured to permit the dry ingredients to be deposited on the meat product exiting the inner elongated flow channel in a variety of configurations, depending on the configuration of the extended portion and how far it extends around the circumference of the inner flow channel. For example, the asymmetrical exit may permit less than 360° of the circumference of the surface of the meat product to have dry ingredients deposited thereon. In another configuration, the asymmetrical exit is configured to permit the dry ingredients to be deposited on less than about 270° or 180° of the circumference of the meat product. The extended portion of the inner elongated flow channel affects how quickly the meat stream depressurizes and in what direction the meat stream expands.

The desired coverage of the dry ingredients may depend on the desired final meat product. In addition, placement of the hoses or tubes 352 may also affect the coverage of the desired final product. Since the asymmetrical exit permits less than 360° of the circumference of the surface of the meat product to have dry ingredients deposited thereon and the expanding diameter allows 360° coverage, if desired. The stuffing horn configuration employed may depend on the desired final product.

FIG. 5 illustrates the meat stream exiting from the inner opening 218 and dry ingredients exiting channels 252 disposed within the conduit 216 between the inner and outer elongated flow channels 212, 214. As can be seen in FIG. 5, the conduit 216 may include a plurality of channels, tubes, or hoses that may direct the dry spice to cover a substantial portion of the outside surface of the meat product. The channels 252 are arranged in conduit 216 to distribute the dry ingredients in the conduit 216. These channels 252 may be welded to the outside of inner elongated flow channel or they may be secured via a clip or retainer 205, such as that shown in FIG. 5.

FIGS. 6 and 7also illustrate a plurality of hoses 352 around the inner elongated flow channel 314. By having the dry ingredients separated into several hoses 252, 352, the dry ingredients are less able to pool into one area of the conduit 216, 316. The hoses 252, 352 are configured to deliver the dry ingredient through the conduit between the inner an outer elongated flow channels from the inlet to the exit. By one approach, hoses 252, 352 may have an inside diameter of between about 0.2 to 0.5-inch. In one illustrative embodiment, the dry ingredient hoses 252, 352 have an inside diameter of approximately 0.375-inch. Further, the hoses may have an air flow of between approximately 25- to 65-standard-cubic-feet-per-hour. In one illustrative approach, the air flow in the dry ingredient hoses is approximately 45-standard-cubic-feet-per-hour.

The stuffing horn 10 may also incorporate a diffuser positioned approximate the first and second exits of the flow channels. The diffuser may help spread the dry ingredients out over the outer surface of the meat. A variety of diffuser elements are contemplated. The diffuser elements at the end of the dry ingredient channels 52 permit the dry ingredients to diffuse over a larger portion of the surface area of the meat stream.

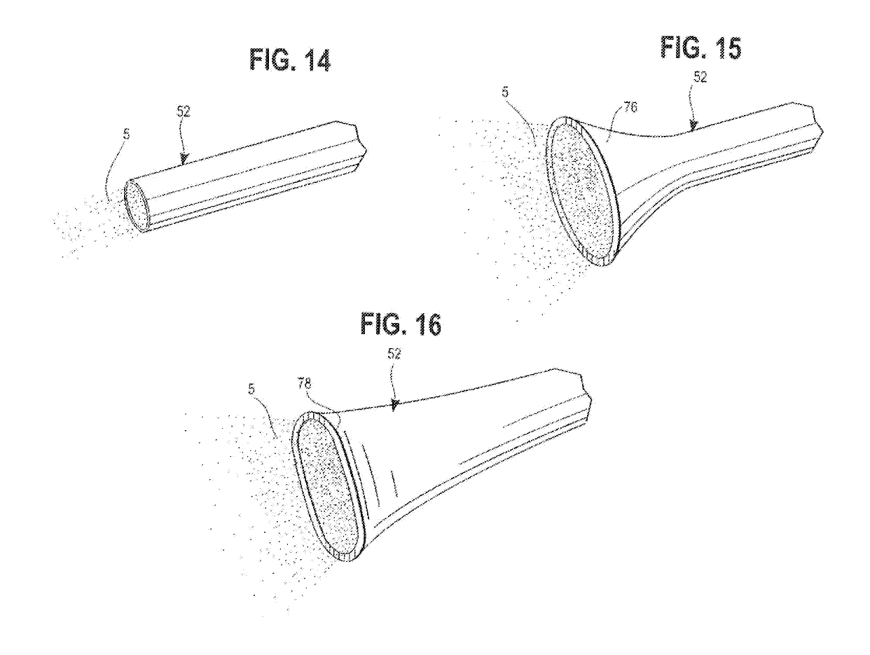

Turning now to FIGS. 14-16, where several dry ingredient tubes or channels 52 are illustrated. FIG. 14 illustrates a channel 52 having a standard circular cross section at the end that has the same circumference at the end as channel 52 upstream of the end. FIG. 15 illustrates a channel 52 having a diffuser nozzle 76 at the end thereof, which expands outward from the channel 52 and has a larger circumference at the end of the diffuser nozzle 76 than the channel 52 has upstream of the end. The diffuser nozzle 76 allows the dry ingredients 5 to expand outward and cover more area. FIG. 16 illustrates a channel 52 having a flattened end portion 78 that has the same circumference as the remainder of the channel 52 but has an oval shape at the end. As mentioned above, if a flattened end portion 78 is created at the end of the dry ingredients channels 52, the long axis of the oval shape will be oriented along the circumference of the inner elongated flow channel 14. Thus, the dry ingredients 5 exiting the flattened end 78 of channel 52 cover a wider portion or the meat surface, though the ingredients 5 may not be as thickly applied because they are spread over a wider area. In sum, the diffuser elements may include the diffuser nozzle 76 or the flattened end 78 to help spread the dry ingredients over a larger portion of the surface area of the meat stream.

The diffuser element having a somewhat flattened end 78 is also illustrated in FIGS. 6-7. The oval or oblong cross section at the exits of the channels have a long axis positioned approximately along the circumferences of the inner and outer elongated flow channels and a short axis positioned roughly perpendicular or normal to the circumference of the flow channels. As illustrated in FIG. 6, the end of the channels 352 has an oval cross section, with an upstream portion of the tubes 52 having a circular cross section. FIG. 7 illustrates the cross section of stuffing horn 310 at the end of the channels 352. While the oval cross section of the exit of the channels 352 is shown, the circular shape of the tubes upstream from the exit is also illustrated and shows that the flattened, oval shape of the diffusing end permits the dry ingredient to be more widely distributed within the conduit 316 around the inner opening 318.

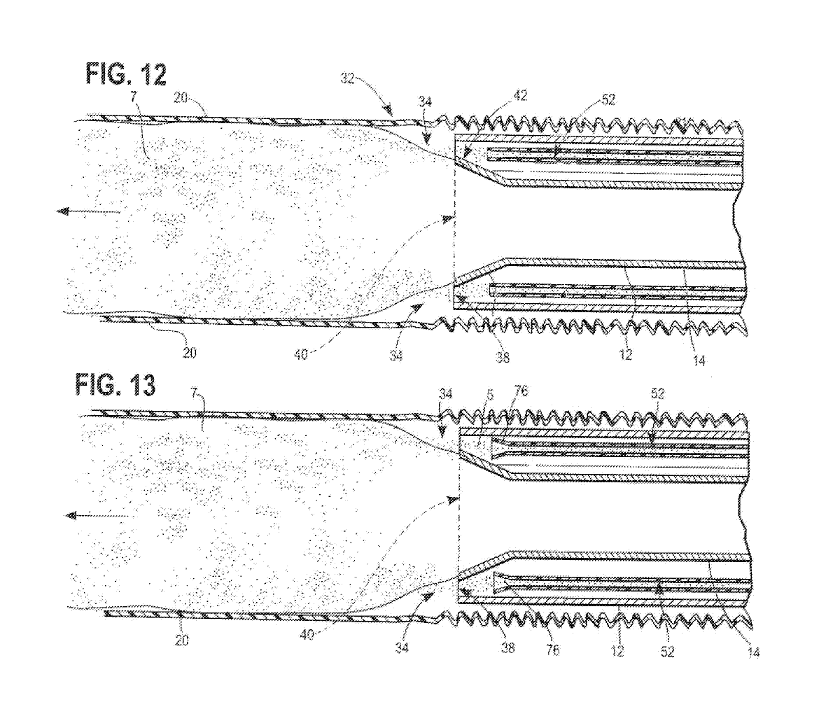

As mentioned, the diffuser element may include a diffuser nozzle, as illustrated in FIG. 13 as reference numeral 76. A diffuser nozzle 76 may be attached to or may be an integral portion of the dry ingredient channel 52. The diffuser nozzle 76 has an increasingly larger diameter than the dry ingredient tubes channel 52 such that the dry ingredients within the channel 52 are permitted to expand outward into the diffuser nozzle 76 prior to exiting the channel 52.

It is anticipated that the stuffing horn, including the inner and outer elongated channel and the hoses, may be comprised of a variety of materials. In one illustrative embodiment, the stuffing horn is comprised of food grade material such as, for example, stainless steel, titanium, titanium alloy, aluminum, aluminum alloy, a plastic material such as Delrin, and certain composite materials. Furthermore, the dry ingredient hoses or tubes may be welded to the flow channels to ensure proper placement of the hoses within the conduit. In addition, the hoses or tubes may be machined out a single piece of metal or other material or attached via a clip or retainer.

An alternative configuration of a stuffing horn is illustrated in FIG. 10. Stuffing horn 610 is manufactured out of a single piece of material, such as a solid block 660 of stainless steel, and then the inner opening 618 is created by removing material from the inside of the block 660. Once the material is removed, the inside surface of the block 660 comprises the inner elongated flow channel 614. Further, an outer elongated flow channel 612 is positioned around the block 660 and connects to the inner elongated flow channel 614 via supporting elements 662 that extend from the block 660. Supporting elements 662 extend from the block 660 on only a portion of the circumference such that they do not interfere with the tubes that will be placed in the conduit 616 between the outer surface of the block 660 and the outer elongated flow channel 612. Stuffing horn 610 has an expanding diameter portion 642 much longer than those previously illustrated. For example, the constant diameter portion 644 is much shorter than the expanding diameter portion 642. It is anticipated that either the constant diameter portion may be much longer or shorter than the expanding diameter portion. It is also anticipated that a constant diameter portion may not be employed for some configurations with an expanding diameter.

In FIG. 10, the expanding diameter portion 642 is comprised of two portions: an upstream portion 670 and a downstream portion 672. The upstream portion 670 of the expanding diameter portion 642 has a first constantly increasing diameter and the downstream portion 672 has a second constantly increasing diameter. The change in the increasing diameter of the inner elongated flow channel 614 occurs at point 674. Such a long expanding portion allows the meat stream to depressurize quite significantly prior to the exit of the inner elongated flow channel. Further, FIG. 10 illustrates that the second, downstream expanding portion 672 may have a slightly faster expanding diameter and, thus, once the meat stream nears the exit of the inner elongated flow channel 614, the meat stream may more quickly depressurize.

As mentioned above, the void space 34 works in conjunction with the exits 38, 40 to permit expansion of the meat stream. By one approach, the void space is created, in part, by allowing the meat to expand prior to the end of the channels such that, when the inner elongated flow channel terminates, the meat does not rapidly expand but slowly expands so that the dry ingredients may apply to the outer surface of the meat, as opposed to mixing with the meat, which can occur when the meat rapidly expands. More specifically, the expansion of the meat results in a depressurizing of the meat stream such that the void space 34 is not rapidly filled with the meat stream when the meat stream reaches the exits 38, 40 and the void space 34. By having the void space 34 remain free of the meat stream, the dry ingredients may expand and diffuse to cover a larger portion of the outside surface of the meat stream prior to the meat contacting the casing. The configuration of the stuffing horn and the void space 34 may depend on the desired final meat product. The meat stream may expand in a uniform manner or the meat may expand in an asymmetrical manner and, thus, the dry ingredients may be applied uniformly around the meat stream or may be applied asymmetrically around only a portion of the meat stream.

An example of the configuration permitting uniform expansion of the meat stream is illustrated in FIG. 4. The exit 240 has an expanding diameter 242 with a frustoconical configuration that permits the meat stream to expand outward in all directions around the circumference of the inner elongated flow channel 214. Further, an expanding diameter portion having such a fustoconical configuration allows void spaces 34 to be created around the circumference of the expanding diameter portion, as discussed in more detail below.

An example of the configuration permitting asymmetrical expansion of the meat stream is illustrated in FIG. 6. The exit 340 has a guard portion 336 that does not permit the meat stream to expand upward but, by having the end of the inner elongated flow channel 314 terminate upstream of the guard portion 336, the meat stream may expand downward. Thus, the meat stream may expand outward around a portion of the circumference of the inner elongated flow channel 314.

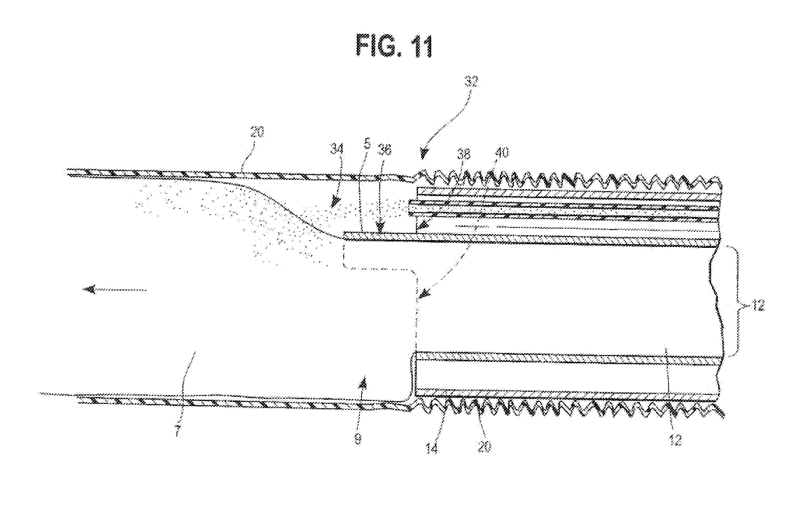

The various configurations are further illustrated in FIGS. 11-13. As mentioned, the void space 34 may be created in a number of manners and primarily provides separation between the casing 20 and the meat 5 where the dry ingredients 7 can be applied. The void space 34 is, in part, created by permitting the meat stream to expand and depressurize sufficiently such that at the point where the dry ingredients are to be applied to the surface of the meat stream (the void space 34), the meat does not rapidly fill this space but, instead, slowly expands to the outside of the casing. The void space 34 also is created, in part, by the configuration of the exits 38, 40 of the inner and outer elongated flow channels 12, 14.

FIG. 11 illustrates one example of how the meat stream 7 may depressurize to facilitate application of the dry ingredients 5 to the outside surface of the meat stream 7. As shown, the meat stream 7 may expand downward 9 away from the extended portion 36 and fill the casing 20. The portion of the meat stream 7 adjacent the extended portion 36 is not allowed to expand immediately after the end of the inner elongated flow channel 14 and, once the extended portion 36 terminates, the pressure of the meat stream has decreased such that the meat stream does not rapidly fill void space 34 but, instead, allows the dry ingredients 5 to diffuse over the surface of the meat stream prior to the meat stream contacting the casing 20. FIG. 11 illustrates that void space is positioned above and just downstream from the extended portion 36. As illustrated in this configuration, the void space 34 is disposed between the surface of the meat stream 7 and the casing 20.

FIG. 12 illustrates inner and outer elongated flow channels 12, 14 in another configuration having an expanding diameter portion 42 and dry ingredients hoses 52 set back from the end of the outer elongated flow channel 14. In the configuration of FIG. 12, the meat stream 7 expands and depressurizes, at least partly, while the meat is still within the expanding diameter portion 42 of the flow channel 14. Therefore, when the meat stream 7 reaches the exit 40, the meat stream 7 does not rapidly expand to fill the casing 20 but slowly expands, thereby allowing the dry ingredients 5 to diffuse and cover the surface area of the meat stream. The expanding diameter portion 42 permits the void space 34 to be created around the circumference of the inner elongated flow channel and is illustrated in FIG. 12 at the top and bottom of the meat stream exiting the flow channel 14. The meat stream 7 shown in FIG. 12 fills the casing 20 more gradually than the meat stream 7 that is shown in FIG. 11 where the meat stream adjacent the lower portion of casing 20 is filled more quickly such that no void space 34 is created. In FIG. 12, by permitting depressurization of the meat 7 prior to exiting the inner elongated flow channel 14, the meat stream 7 does not rapidly fill the void space 34 and, instead, the void space 34 remains such that the dry ingredients 5 may diffuse on the surface thereof.

FIG. 13 shows another configuration of the inner and outer elongated flow channels 12, 14 that is similar to the configuration of FIG. 12. FIG. 13 illustrates the meat stream 7 expanding uniformly around the circumference of the inner elongated flow channel 14 and also illustrates diffuser nozzles 76 at the end of dry ingredient channels 52. The diffuser nozzles, as discussed above, permit the dry ingredients 5 to expand to cover a larger portion of the surface area of the meat stream 7.

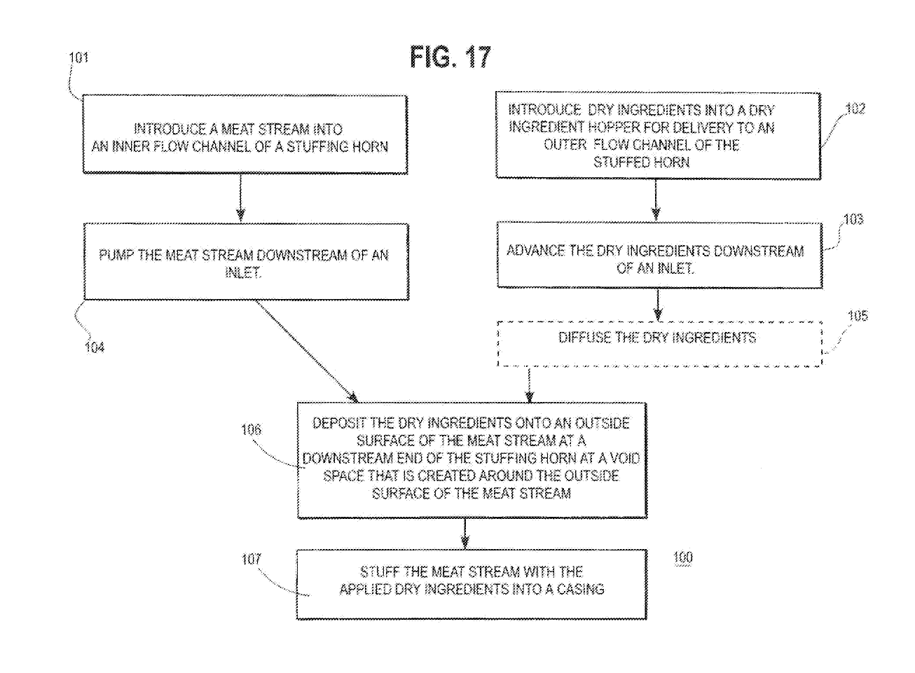

Turning now to FIG. 17, process 100 is shown. A method for applying dry ingredients to a meat product in the form of a meat log comprises introducing 101 a meat stream into an inlet connected to an inner elongated flow channel of a stuffing horn. The meat stream may include at least one of: a whole muscle meat mixture, a meat batter, and a meat analog mixture, to note a few options.

Method 100 further includes introducing 102 dry ingredients into a dry ingredient hopper that is connected to a screw feed for delivery of the dry ingredients to an inlet connected to an outer elongated flow channel of the upstream end of a stuffing horn. Further, the inner elongated flow channel may be substantially disposed within the outer elongated flow channel such that an intermediate conduit is disposed between the two flow channels. The introduction 102 of the dry ingredients into the dry ingredient hopper may further include pumping the dry ingredient into the stuffing horn.

Introducing 102 the ingredients into a dry ingredient hopper may further include entraining the dry ingredients into an air stream to move the dry ingredients from the inlet to the exit of the stuffing horn where the dry ingredients will be applied to the outside surface of the meat product. A venturi-style pump may be employed to entrain the dry ingredients into an air stream. More particularly, a venture-style pump may be positioned at an exit of a screw feeder of the hopper. Depending on the desired final product, the air stream having the dry ingredients entrained therein may have an air flow of approximately 15- to 25-ft³/hour.

As illustrated in FIG. 17 process 100 further includes advancing 103 the dry ingredients downstream of the inlet of the outer elongated flow channel. A tube or a plurality of tubes may be employed to advance the dry ingredients downstream of the inlet of the outer elongated flow channel. By one approach, the tubes may deliver approximately 0.1- to 0.2-ounces-per-second of the dry ingredients to the exit of the stuffing horn. In one illustrative embodiment, the stuffing horn includes a plurality of four tubes that together deliver approximately 0.4- to 0.8-ounces-per-second of the dry ingredient to the exit of the stuffing horn where the ingredients are applied to the outside surface of the meat stream. In another configuration, the plurality of tubes delivers approximately three ounces of the dry ingredient to the exit of the stuffing horn in about five seconds. Depending on the desired final product, it is anticipated that the dry ingredient advance downstream may be between 0.5- to 12.0-ft³/hour.

The method 100 for applying dry ingredients to a meat product may also comprise pumping 104 the meat stream downstream of the inlet of the inner elongated flow channel such that the meat may advance through the opening within the inner elongated flow channel to the exit of the stuffing horn.

Method 100 also includes depositing 106 the dry ingredients onto an outside surface of the meat stream at a downstream end of the stuffing horn at a void space that is created around the meat stream. The dry ingredients are deposited 106 onto the meat stream surface prior to the meat stream contacting the casing. Prior to depositing 103 the dry ingredients, method 100 may further include diffusing 105 the dry ingredients. Diffusing 105 the dry ingredient helps spread the dry ingredients over the outside surface to avoid pooling of the dry ingredients such that the ingredients are not concentrated over a single area of the surface of the meat. The method 100 further includes stuffing 107 the meat stream with the applied dry ingredients into a casing such as those casings mentioned above.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

We claim:

1. An apparatus for applying dry ingredients to an outer surface of meat product, the apparatus comprising:
a meat supply device including a pressure source for pressurizing the meat product;
an elongated meat flow channel having an upstream, intake end and a downstream, exit end with the intake end receiving the pressurized meat product which flows downstream through the flow channel for being discharged from the exit end thereof;
an airflow device including a pressure source for generating a flow of air;
dry ingredient entrainment mechanism connected to the air flow device for supplying dry ingredients thereto to be entrained in the flow of air; and
an elongate air flow channel adjacent the meat flow channel having an upstream, intake end and downstream, exit end adjacent the exit end of the meat flow channel with the intake end receiving the flow of air which flows downstream through the air flow channel with the dry ingredients entrained therein for being discharged from the exit end and deposited on an outer surface of the meat product as the meat product is discharged from the adjacent meat flow channel exit end.

2. The apparatus of claim 1 wherein the exit ends are configured to permit the meat product to depressurize after the dry ingredients are discharged from the air flow channel.

3. The apparatus of claim 2 wherein exit ends are configured to permit the meat product to depressurize before application of the dry ingredients to the outer surface of the meat product and the elongated air flow channel includes a diffuser approximate the exit ends.

4. The apparatus of claim 1 further comprising an asymmetrical exit at the downstream, exit end of the elongated meat flow channel.

5. The apparatus of claim 4 wherein the asymmetrical exit of the elongated meat flow channel comprises an extension piece that extends from the elongated meat flow channel.

6. The apparatus of claim 4 wherein the asymmetrical exit of the elongated meat flow channel comprises a slanted tip configured to terminate the elongated meat flow channel at an angle.

7. The apparatus of claim 1 further comprising an expanding diameter portion at the downstream exit end of the elongated meat flow channel.

8. The apparatus of claim 1 wherein the apparatus is configured to have casings disposed at least around the meat product as it is discharged from the meat flow channel exit end.

9. A stuffing horn apparatus comprising:
a first elongated flow channel;
a second elongated flow channel disposed adjacent the first elongated flow channel; and
a first inlet disposed at an upstream portion of the first elongated flow channel, the first inlet configured to introduce at least one meat into the first elongated flow channel;
a second inlet disposed at an upstream portion of the second elongated flow channel, the second inlet configured to introduce at least one dry ingredient into the second elongated flow channels, the at least one dry ingredient being moved through the second elongated flow channel in an air stream; and
an end portion of the stuffing horn configured to create a void space around the meat wherein the at least one dry ingredient is deposited onto an outside surface of the meat at the void space.

10. The apparatus of claim 9 wherein the end portion of the stuffing horn are configured to permit the at least one meat stream to depressurize prior to application of the at least one dry ingredient.

11. The apparatus of claim 9 wherein the at least one dry ingredient is entrained in an air stream in the second elongated flow channel to move the dry spice from the second inlet to the end portion of the stuffing horn.

12. The apparatus of claim 9 further comprising an exit of the first elongated flow channel, the exit comprising at least one of:
an asymmetrical exit of the first elongated flow channel; and
an exit of the first elongated flow channel having an expanding diameter.

13. The apparatus of claim 12 wherein the asymmetrical exit of the first elongated flow channel is configured to permit the at least one dry ingredient to be deposited on less than about 360° of a circumference of the at least one meat exiting the first elongated flow channel.

14. The apparatus of claim 12 wherein the asymmetrical exit of the first elongated flow channel is configured to permit the at least one dry ingredient to be deposited on less than about 180° of a circumference of the at least one meat exiting the first elongated flow channel.

15. The apparatus of claim 12 wherein the asymmetrical exit of the first elongated flow channel further comprises at least one of:
a guard piece that extends from an end of the first elongated flow channel around a portion of the circumference; and
a slanted tip such that the first elongated flow channel terminates at an angle.

16. The apparatus of claim 12 wherein the first and second elongated flow channels are tubular shaped, have substantially constant diameters along a length of the first and second elongated flow channels, and are coaxially arranged with the first elongated flow channel disposed substantially within the second elongated flow channel.

17. The apparatus of claim 16 wherein the exit of the first elongated flow channel having an expanding diameter is positioned downstream of a portion of the first elongated flow channel having the substantially constant diameter along the length, the expanding diameter having a diameter increasingly larger than the substantially constant diameter along the length of the first elongated flow channel.

18. The apparatus of claim 12 wherein a distance between the first and second elongated channels at the exit of the expanding diameter is approximately 0.2-inch.

19. The apparatus of claim 12 wherein a distance between the first and second elongated channels at the exit of the expanding diameter is approximately 0.25-inch.

20. The apparatus of claim 9 further comprising at least one dry ingredient hose configured to deliver the at least one dry ingredient through the second elongated flow channel.

21. The apparatus of claim 20 wherein the at least one dry ingredient hose comprises a hose with an inside diameter of approximately 0.375-inch and having an air flow of approximately 45-standard-cubic-feet-per-hour.

22. The apparatus of claim 20 further comprising a plurality of dry ingredient hoses configured to deliver the at least one dry ingredient through the second elongated flow channel.

23. The apparatus of claim 20 further comprising a diffuser approximate the exits of the first and second elongated flow channels.

24. The apparatus of claim 23 wherein the diffuser is positioned at an end of the at least one dry ingredient hose.

25. The apparatus of claim 24 wherein the diffuser comprises at least one of:
at least one channel opening at the end of the at least one dry ingredient hose configured to permit the at least one dry ingredient to advance therethrough;
a diffuser nozzle; and
an oval configuration at the end of the at least one dry ingredient hose.

26. The apparatus of claim 9 wherein the first elongated flow channel has a first end and the second flow channel has a second end located a distance downstream of the first end such that the first elongated flow channel terminates at a distance upstream of the second elongated flow channel thereby creating the void space at the end portion of the stuffing horn.

27. The apparatus of claim 9 wherein the first elongated flow channel has a first end and the outer flow channel has a second end located a distance upstream of the first end such that the first elongated flow channel terminates at a distance downstream of the second elongated flow channel thereby creating the void space at the end portion of the stuffing horn.

28. The apparatus of claim 9 further comprising a dry ingredient hopper and a dry ingredient screw feed.

29. The apparatus of claim 28 further comprising a venturi pump configured to receive the at least one dry ingredient from the dry ingredient screw feed and to advance the at least one dry ingredient through the second inlet to the second elongated flow channel to move the at least one dry ingredient downstream by entraining the at least one dry ingredient in a moving air stream.

30. The apparatus of claim 9 further comprising a dry ingredient pump configured to advance the at least one dry ingredient through the second elongated flow channel.

31. The apparatus of claim 9 further comprising a pump system configured to advance the at least one meat through the first elongated flow channel.

32. The apparatus of claim 9 wherein the apparatus is configured to have casings disposed at least at the end portion of the stuffing horn.

33. The apparatus of claim 32 wherein the casings lack any stuck holes therethrough.

34. A method for applying dry ingredients to a meat log, the method comprising:
introducing a meat stream into an inner inlet connected to an inner elongated flow channel at an upstream end of a stuffing horn;
introducing at least one dry ingredient into a dry ingredient hopper, the dry ingredient hopper connected to a screw feed for delivering the at least one dry ingredient to an outer inlet, the outer inlet connected to an outer elongated flow channel at the upstream end of the stuffing horn, the inner elongated flow channel disposed substantially within the outer elongated flow channel such that the outer inlet delivers the at least one the dry ingredient to an intermediate conduit located between the inner and outer elongated flow channels;
advancing the at least one dry ingredient downstream of the outer inlet and directing the at least one dry ingredient to an application area;
pumping the meat stream downstream of the inner inlet and depressurizing the meat stream prior to exposure to a substantial portion of the at least one dry ingredient;
depositing the at least one dry ingredient onto an outside surface of the meat stream at a downstream end of the stuffing horn wherein a void space is created at the application area, the void space positioned at least partially around the outside surface of the meat stream where the at least one dry ingredient is permitted to contact the outside surface of the meat stream; and
stuffing the meat stream with the applied at least one dry ingredient into a casing.

35. The method of claim 34 further comprising diffusing the at least one dry ingredient prior to depositing the dry ingredient onto the outside surface of the meat stream.

36. The method of claim 34 wherein introducing the at least one dry ingredient further comprises entraining the at least one dry ingredient in an air stream.

37. The method of claim 34 wherein advancing the at least one dry ingredient downstream of the outer inlet employs a plurality of tubes, each of the plurality of tubes delivering approximately 0.1 to 0.2-ounces-per-second of the at least one dry ingredient.

38. The method of claim 37 wherein a plurality of tubes comprise four tubes that together deliver approximately 0.4 to 0.8-ounces-per-second of the at least one dry ingredient to the outside surface of the meat stream.

39. The method of claim 34 wherein advancing the at least one dry ingredient downstream of the outer inlet employs a plurality of tubes, the plurality of tubes delivering approximately three ounces of the at least one dry ingredient in five seconds.

40. The method of claim 34 wherein advancing the at least one dry ingredient downstream of the outer inlet further comprising advancing a volume of the at least one dry ingredient wherein the volume is approximately 0.5 to 12.0 ft³/hour.

41. The method of claim 34 wherein entraining the at least one dry ingredient in an air stream employs a venturi pump positioned at an exit of the screw feeder to introduce the dry ingredient into the intermediate conduit.

42. The method of claim 34 wherein introducing the at least one dry ingredient further comprises pumping the at least one dry ingredient into the stuffing horn.

43. The method of claim 34 wherein entraining the at least one dry ingredient in an air stream comprises having an air flow of approximately 15 to 25-W/hour.

44. The method of claim 34 wherein the meat stream comprises at least one of:
a whole muscle meat mixture;
a meat batter; and
a meat analog.

45. The method of claim 34 further comprising cooking the casing having the meat stream stuffed therein and minimizing yield loss of the meat log.
